(19) United States
(12) Patent Application Publication
(10) Pub. No.: US 2009/0313354 A1
(43) Pub. Date: Dec. 17, 2009

(54) DEVICE, SYSTEM, METHOD AND COMPUTER-READABLE MEDIUM FOR STORING AND MAKING IMAGE INFORMATION RETRIEVABLE

(75) Inventor: Gerard Vrijburg Sjoerd, Rotterdam (NL)

Correspondence Address: BROOKS KUSHMAN P.C., 1000 TOWN CENTER, TWENTY-SECOND FLOOR, SOUTHFIELD, MI, 48075, US

(73) Assignee: SNAPLINK B.V., HC Rotterdam (NL)

(21) Appl. No.: 12/293,008

(22) PCT Filed: Mar. 14, 2007
(86) PCT No.: PCT/NL07/00072

§ 371 Date: Jan. 5, 2009

(30) Foreign Application Priority Data
Mar. 14, 2006 (NL) 1031369

(51) Int. Cl. G06F 15/16; G06F 12/00

(52) U.S. Cl. 709/219; 711/154; 711/103; 711/E12.001

(57) ABSTRACT

The present invention relates to a method for storing, providing with a code and making image information retrievable, comprising steps for: transferring image data from a memory card for mobile use, such as a flash memory, to a memory in a device coupled to a network, a user entering in the device a contactability code for a mobile telephone, such as a mobile telephone number or another code such as an IP telephony address, associating the image data with the contactability code or an identification code, transmitting the image data from the device to be received by the web server or a data file linked thereto.

The present invention relates to a method for storing, providing with a code and making image information retrievable. The invention further relates to a device for storing, providing with a code and making image information retrievable. The invention further relates to a system for storing, providing with a code and making image information retrievable. The invention further relates to software and a storage medium comprising the software for storing, providing with a code and making image information retrievable.

Owing to the digitization of the photography industry it has become increasingly easy for users of digital photo and film cameras to make digital photos and films. Many photos and films are shot away from home. Photos and films are usually made with the purpose of also allowing others to enjoy the results. A drawback of storing photographs on memory cards is that many digital photos and films can be seen only by the relevant user or photographer in particular and are not so readily visible to others. This occurs particularly if a user or photographer is away from home. An additional fact is that memory cards of digital photo and film cameras are filled by recording photos and/or films. This is a particular drawback when the user or photographer is away from home.

In order to provide a solution herefor the present invention provides a method for storing, providing with a code and making image information retrievable, comprising steps for:
transferring image data from a memory card for mobile use, such as a flash memory, to a memory in a device coupled to a network,
a user entering in the device a contactability code for a mobile telephone, such as a mobile telephone number or another code such as an IP telephony address,
associating the image data with the contactability code or an identification code,
transmitting the image data from the device to be received by the web server or a data file linked thereto.

An advantage of such a method according to the present invention is that the images become immediately available to the user, even if he/she is on the other side of the world. The user can further use the memory card for other images and the user has a backup of the images. Examples of applications of the device are public places such as post offices, hotels, cafes, holiday parks, airports, stations, shops, fast-food chains, tourist offices, event sites, conference and exhibition centres, internet cafes, petrol stations, amusement parks etc. The mobile device will usually be suitable for retrieving the images for viewing thereof, although the user can use any workstation with internet access for this purpose.

A memory card on which digital photo and/or film images are stored is defined in the context of the invention as a removable memory carrier which is used by a user in a digital photo or film image recording device to store digital photos and/or film images after they have been recorded with a digital photo and/or film image recording device intended for this purpose.

In a first preferred embodiment the method comprises steps for transmitting to the contact address and/or the associated mobile device, by means of for instance a message such as an SMS or an MMS, of a second code such as a web server address, such as a URL, and/or log-in data, wherein the second code is associated with the contactability code and/or the image information. By means of these steps the web server and/or the device or an additional computer can provide the mobile device of the user with the address of the server and/or the log-in data. These data can be received in practical manner on a mobile device which the user generally carries with him/her anyway.

The method preferably comprises steps for connecting to the web server using a computer and retrieving the image data on the basis of the second code. As stated, the user can retrieve the photographs at any time and from any internet station.

The contactability code is preferably the same as the log-in code. This embodiment has the advantage that it is easy to remember since the user generally knows his/her own contactability code by heart.

A further embodiment of the method comprises steps for linking image information of a plurality of memory cards of a possible plurality of users to a code. A combined ‘photo album’ can hereby be created.

A further aspect of the present invention relates to a device for reading photo and/or film images from a memory storage of a camera at a public location accessible to consumers, for the purpose of storage thereof in a computer memory of a remotely placed server and transport thereof via a computer network, wherein the device comprises:
a housing,
memory card reading means which are arranged in the housing for reading photo and/or film images stored in memory cards,
at least one memory for temporary storage of photo and/or film images,
at least one processing unit for processing instructions and data,
a network connector arranged in or on the housing for providing a connection to a computer network,
an input member for entering a contactability code of a mobile device for receiving a second code and/or log-in data relating to a user by means of a mobile device linked to the contactability code.

The input member of the device herein preferably comprises a keyboard and/or a touch screen. The keyboard is relatively advantageous in respect of the production thereof. A touch screen provides a flexible and attractive operating interface.

The device and/or software of the device preferably comprises selection means for determining which images from his or her memory card must be stored. Less desired images can hereby be deleted or left on the card.

The device can preferably be placed at locations away from home and/or can be operated directly by end users without the intervention of a professional intermediary.

A further aspect of the present invention relates to a system for making a code available to the user via a telecommunication network, comprising:
a first computer for establishing a connection to a device as according to one or more of the claims 6-11 via a computer network,
software for performing steps according to a method as according to one or more of the foregoing claims 1-5.

In the system a part of the second code is preferably a field in a data file. The user can more preferably pay for making use of the service by means of payment via his or her payment system associated with the contact address.

A further aspect of the present invention relates to a machine-readable medium comprising program code means which can be executed on a device according to the invention for the purpose of implementing a method according to the invention.

A further aspect of the present invention relates to a machine-readable medium comprising program code means which can be executed on a server according to the invention for the purpose of implementing a method according to the invention.

Some advantages of the present invention become apparent in an example wherein someone wishes to make photo and/or film images available to others in simple manner when away from his/her home environment. He/she has only to place his/her memory card in the image uploading device, these being deployed at suitable locations for this purpose, and type in a personal telephone number, and the system supplies a code to a wireless appliance of for instance the user via a telecommunication network. It is not necessary to be at home to receive this code. In combination with the local availability of an image uploading device, this is a great advantage.

If desired, photographs can be uploaded subsequently to or simultaneously with friends or colleagues doing so. With the code a user can view his and/or her images via a computer, and the user will know in any case that the images are stored somewhere. As soon as the code has been received, a user can optionally consider wholly or partially deleting the images on his or her memory card. The memory card can then be used once again to store new images as long as a user is still away from home. As soon as the code has been received, a user can consider also passing on this code to other people.

It is not necessary to be at home for this purpose either. These other people can therefore retrieve the images from a data file on the server. It is possible here that the user did not take the photos him/herself. He or she can also insert the memory card of someone else.

Further advantages, features and details of the present invention will be described on the basis of further preferred embodiments, which are shown in the accompanying figures, in which;

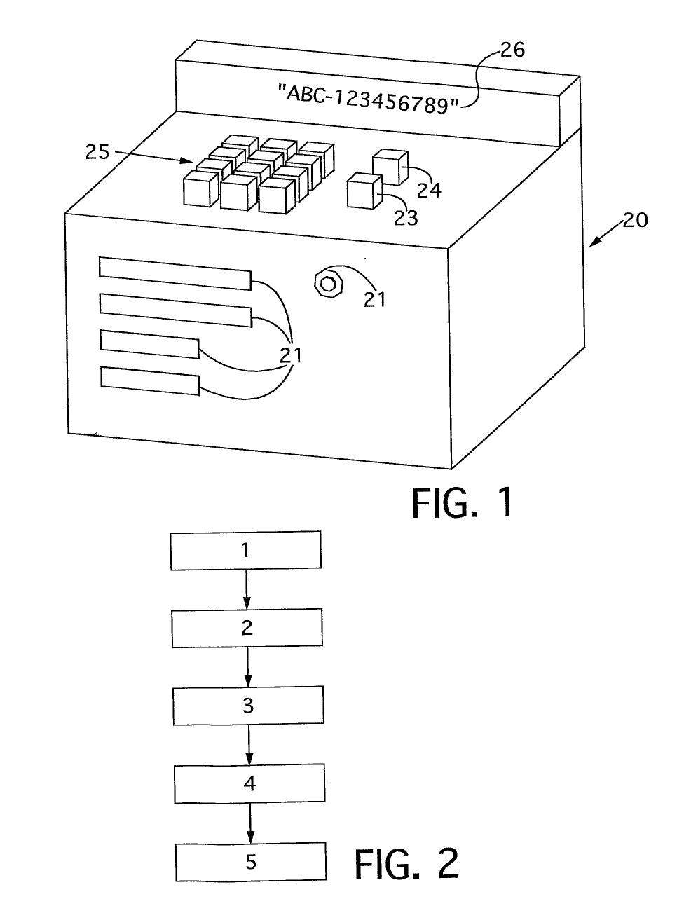

FIG. 1 is a perspective view of a first embodiment of an image uploading device of the present invention,

FIG. 2 is a flow diagram of a further embodiment according to the present invention,

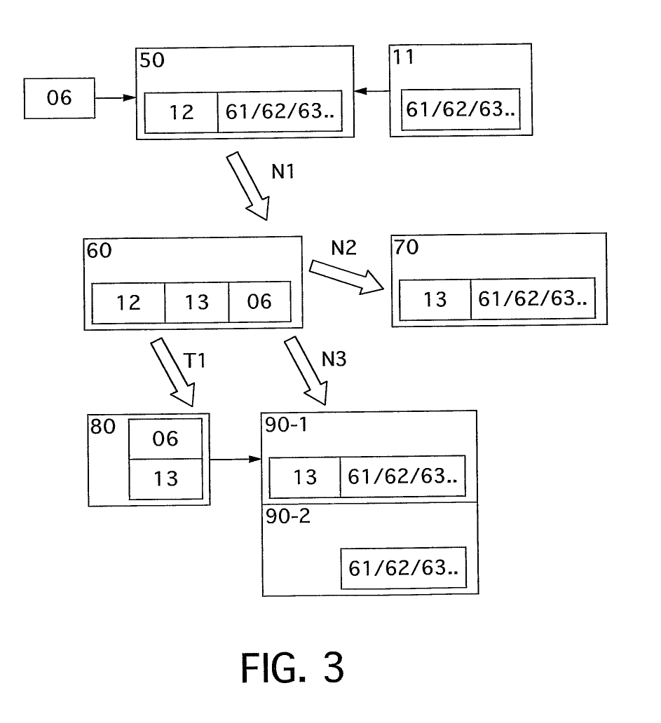

FIG. 3 is a block diagram of further embodiments according to the present invention.

A first embodiment (FIG. 1) according to the present invention relates to an image uploading device 20 comprising elements such as a numerical keyboard 25, memory card reading means 21 for practically all common types of memory card, a display 26, an indicator lamp 22, input keys 23,24, a memory storage comprising for instance a ROM, RAM, Flash and/or hard disc and a processing unit (not shown). By means of connecting means the device is connected to the mains or to batteries, and to a network connection.

In a preferred embodiment of a method according to the present invention (FIG. 2) the image uploading device is connected in step 1 at a location to the mains or to batteries, and to a network connection. A connection must here be established between the device and a computer network. The computer network preferably comprises of the internet and/or an internet access connection. The latter can comprise an ADSL connection or cable connection, but also a wireless network connection such as WiFi, in order to enable placing of the device at a practical location close to an ADSL or cable connection. This step and other steps are not per se limitative for the invention in the light of the definition of the invention in the claims. This representation of the steps on the basis of this figure is a description of the scope within which the invention can be applied by the skilled person.

In step 2 a user inserts a memory card in the image uploading device in a suitable slot of those slots 21 available for this purpose. In order to be able to receive log-in data on his/her mobile telephone, the user types in a telephone number on this image uploading device. At a given moment the user presses a confirm or “OK” key on this image uploading device. The object of this method is that, without a separate instruction input, a start is made with copying of image data from the memory card to the internal image storage means of the image uploading device, and then with transfer of these image data via the computer network to a server computer with a data file for storing the images.

A first code is also given to the image data by the coupled systems. This code is associated with or the same as a second code which for instance comprises a contact address of a server which can for instance be accessed via internet. The object is that the user can view the images with the code by making contact with the server, and can for instance also give the code to others so that they can also make contact with the server in order to view the images.

In step 3 the user is informed that his or her images have been copied correctly to the internal image storage means of the image uploading device. A message to this effect can for instance be shown on the display and/or a lamp generates a colour or intermittent signal by way of information. The user can remove his or her memory card from the device. The user does not have to wait for the whole upload process to finish.

In step 4 a second code is sent to the wireless telecommunication appliance of the user via a telecommunication network. This operation can be performed once all the images have been moved completely via a computer network to a data file on a computer adapted for this purpose, such as a web server. This second code is associated with or the same as the first code, which comprises at least a contact address of a server which can for instance be accessed via internet. The first code can form part of a combined code which also comprises the second code, but can also be the same code as the second code.

In step 5 the user saves the code and/or forwards the code to others and/or takes the code to a device with which access can be gained to the internet. The object of this method is to make the images visible to the person him/herself and/or to others and/or to store images as ‘backup’ and/or as a new storage medium for the purpose of wholly or partially erasing the relevant memory card and reusing it for storing new images.

FIG. 3 shows schematically a system for storing, coding and distributing images according to the present invention. Images 61/62/63/6./ . . . are copied from a memory card 11, which is inserted into image uploading device 50, to the internal image storage means of image uploading device 50. These images are linked to a first code 12. The first code 12 is generated in a computer 60 and linked via a network connection Ni to the images on the internal image storage means of device 50. A second code 13 is at least determined by the addressing of image data in a data file 70. This second code 13 is associated with or the same as a first code 12. The first code 12 and second code 13 are stored linked in a record in computer 60. At least second code 13 is formulated in a manner which is readable by a person and can be entered into a computer. Code 13 preferably comprises an internet address or URL. The user types in his/her mobile telephone number on the numerical keyboard of image uploading device 50. This mobile telephone number is communicated to computer 60 via a network connection N1 and stored in a record linked together with code 12 and code 13. As soon as images 12/61/62/63/6./ . . . have been moved from the internal image storage means of device 50 to data file 70 via a network connection Ni, computer 60 sends code 13 to the mobile telecommunication appliance 80 of the user via a telecommunication network Ti. The person can then make contact with computer 60 using a device 90-1 for gaining internet access on the basis of second code 13, which he/she has kept via a network connection N3. Computer 60 associates code 13 with the images 13/61/62/63/6./ . . . stored on data file 70. Computer 60 and data file 70 are mutually connected via a network connection N2. A copy of images 13/61/62/63/6./ . . . is subsequently sent from data file 70 to device 90-1. This device can be a PC, laptop, mobile telephone, palm computer, gaming device etcetera. The images are then shown on a display screen 90-2. With the object of saving network and/or computing capacity, these images can be of a lower resolution sufficient to fill a screen. The original files are per se also available to the user and can be ‘downloaded’ to device 90-1 at any moment via network connection N3 by means of instructions via device 90-1.

The present invention is described in the foregoing on the basis of several preferred embodiments. Different aspects of different embodiments are deemed described in combination with each other, wherein all combinations which can be made by a skilled person on the basis of this document must be included. These preferred embodiments are not limitative for the scope of protection of this document. The rights sought are defined in the appended claims.

1. Method for storing, providing with a code and making image information retrievable, comprising steps for:
transferring image data from a memory card for mobile use, such as a flash memory, to a memory in a device coupled to a network,
a user entering in the device a contactability code for a mobile telephone, such as a mobile telephone number or another code such as an IP telephony address,
associating the image data with the contactability code or an identification code, and
transmitting the image data from the device to be received by the web server or a data file linked thereto.

2. Method as claimed in claim 1, comprising steps for transmitting to the contact address and/or the associated mobile device, by means of for instance a message such as an SMS or MMS, of a second code such as a web server address, such as a URL, and/or log-in data, wherein the second code is associated with the contactability code and/or the image information.

3. Method as claimed in claim 1, comprising steps for connecting to the web server using a computer and retrieving the image data on the basis of the second code.

4. Method as claimed in claim 1, wherein the contactability code is the same as the log-in code.

5. Method as claimed in claim 1, comprising steps for linking image information of a plurality of memory cards of a possible plurality of users to a code.

6. Device for reading photo and/or film images from a memory storage of a camera at a public location accessible to consumers, for the purpose of storage thereof in a computer memory of a remotely placed server and transport thereof via a computer network, wherein the device comprises:
a housing,
memory card reading means which are arranged in the housing for reading photo and/or film images stored in memory cards,
at least one memory for temporary storage of photo and/or film images,
at least one processing unit for processing instructions and data,
a network connector arranged in or on the housing for providing a connection to a computer network, and
an input member for entering a contactability code of a mobile device for receiving a second code and/or log-in data relating to a user by means of a mobile device linked to the contactability code.

7. Device as claimed in claim 6, wherein the input member comprises a keyboard and/or a touch screen.

8. Device as claimed in claim 6, comprising selection means for determining which images from his or her memory card must be stored.

9. Device as claimed in claim 6, wherein the device can be placed at locations away from home.

10. Device as claimed in claim 6, wherein the device can be operated directly by end users without the intervention of a professional intermediary.

11. Device as claimed in claim 6, wherein a user can download files via the device.

12. System for making a code available to the user via a telecommunication network, comprising:
a first computer for establishing a connection to a device via a computer network, the device comprising:
software for performing steps according to a method as claimed in claim 1.

13. System as claimed in claim 12, wherein at least a part of the second code is a field in a data file.

14. System as claimed in claim 10, wherein the user can pay for making use of the service by means of payment via his or her telecommunication subscription.

15. Method as claimed in claim 1 with use of a device as claimed in claim 6.

16. Machine-readable medium comprising program code means which can be executed on a device as claimed in claim 6 for the purpose of implementing a method as claimed in claim 1.

17. Machine-readable medium comprising program code means which can be executed on a server as stated in claim 6 for the purpose of implementing a method as claimed in claim 1.
